(19) United States
(12) Patent Application Publication
(10) Pub. No.: US 2008/0235609 A1
(43) Pub. Date: Sep. 25, 2008

(54) FUNCTION SWITCHING DURING DRAG-AND-DROP

(76) Inventors: THEODORE R. CARRAHER, Durham, NC (US); Gabriel A. Cohen, San Mateo, CA (US); Ashish Jain, Raleigh, NC (US); Gerald L. Mitchell, Raleigh, NC (US)

Correspondence Address: LAW OFFICE OF JIM BOICE, 3839 BEE CAVE ROAD, SUITE 201, WEST LAKE HILLS, TX, 78746, US

(21) Appl. No.: 11/688,075

(22) Filed: Mar. 19, 2007

(51) Int. Cl. G06F 3/048

(52) U.S. Cl. 715/769

(57) ABSTRACT

A computer-implementable method, system and computer media are presented for allowing a user to change a first type of Drag-and-Drop (DnD) operation into a second type of DnD operation. In one embodiment, the computer-implementable method includes the steps of: detecting a first type of DnD operation in which a cursor is dragging a copy of an original file icon across a Graphical User Interface (GUI); detecting the cursor dragging the copy of the original file icon across a location, on the GUI, at which the original file icon was positioned when the first type of DnD operation was initiated; and in response to detecting the cursor dragging the copy of the original file icon across the location at which the original file icon was initially positioned, converting the first type of DnD operation into a second type of DnD operation.

### BACKGROUND OF THE INVENTION

The present invention relates in general to the field of computers and other data processing systems, including hardware, software and processes. More particularly, the present invention pertains to drag-and-drop operations.

Drag-and-drop (DnD) is a powerful tool in many Graphical User Interface (GUI) based applications. As the name implies, DnD allows a user to use a mouse to place a cursor over a file icon on the GUI, click the mouse to capture the file icon, and, while holding down the mouse click, “drag” the file icon (or a copy of the file icon) to a new location, where it is “dropped.” Two of the most common DnD operations are copying files and moving files between directories.

Referring now to FIG. 1, depicted is a GUI 102 in which a prior art “copy” DnD operation is occurring. Initially clicking “FOLDER A” causes the icons representing Files 1-4 to appear in window 110. By positioning a cursor 104 over File 1 (represented by file icon 108a), a copy (represented by a file icon 108b) of File 1 can be dragged and dropped into SUBFOLDER C1 by holding down the left mouse button (not shown) until the cursor 104 reaches the desired SUBFOLDER C1. The left mouse button is then released, causing a copy of File 1 (represented by file icon 108b) to be dropped into SUBFOLDER C1. Thus, this action causes an underlying copy event to occur, in which an actual copy (or at least a pathway to) the original File 1 is placed into SUBFOLDER C1. Note that an indicator 106 shows that the DnD operation is a “copy” operation (as suggested by the letter “C”, in which one copy of File 1 (represented by file icon 108a) stays in Folder A, while a copy of File 1 (represented by file icon 108b) is created in SUBFOLDER C1.

FIG. 2 illustrates a typical “move” DnD operation. By clicking an alternate button (e.g., “Control”) while clicking a left mouse button, File 1 (represented by file icon 108a) is moved out of Folder A and into SUBFOLDER C1. This action results in an underlying file management, in which the actual original File 1 (represented by file icon 108a), or at least a pathway to the original File 1, is moved into SUBFOLDER C1. Note that the content of indicator 106 is now an “M”, thus suggesting that the DnD operation is a “move” operation. Note also that there is now only the single original File 1 (in SUBFOLDER C1), since the “move” operation does not make a copy of File 1.

A main drawback to the “move” operation shown in FIG. 2 is that it is difficult for a user to remember what alternate key or command is needed to make the DnD operation a “move” operation instead of a “copy” operation.

### SUMMARY OF THE INVENTION

To address the problem described above, presently disclosed are a computer-implementable method, system and computer media for allowing a user to change a first type of Drag-and-Drop (DnD) operation (e.g., “Copy”) operation into a second type of DnD operation (e.g., “Move”). In a preferred embodiment for converting a first type of Drag-and-Drop (DnD) operation (e.g., a “copy” DnD operation) into a second type of DnD operation (e.g., a “move” DnD operation), the computer-implementable method includes the steps of: detecting a first type of Drag-and-Drop (DnD) operation in which a cursor is dragging a copy of an original file icon across a Graphical User Interface (GUI); detecting the cursor dragging the copy of the original file icon across a location, on the GUI, at which the original file icon was positioned when the first type of DnD operation was initiated; and in response to detecting the cursor dragging the copy of the original file icon across the location at which the original file icon was initially positioned, converting the first type of DnD operation into a second type of DnD operation.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 depicts a prior art Drag-and-Drop (DnD) “copy” operation;

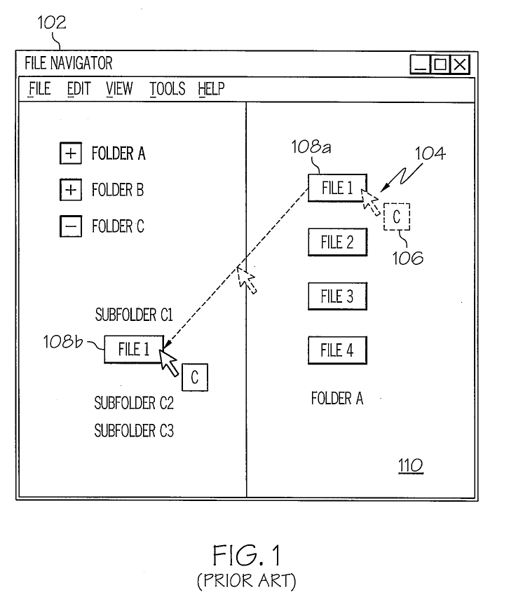

FIG. 2 illustrates a prior art DnD “move” operation;

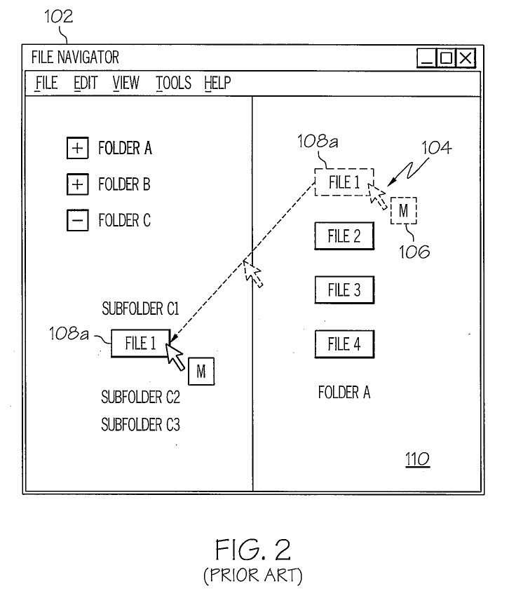

FIG. 3 depicts a “copy” DnD operation using a novel DnD operation that is convertible on-the-fly to a “move” DnD operation;

FIG. 4 illustrates a “copy” DnD cursor approaching a “scoop” operation of a file;

FIG. 5 depicts the “copy” DnD cursor being converted into a “move” DnD cursor after “scooping” the file;

FIG. 6 illustrates the “move” DnD cursor moving the file from a first folder to a second folder;

FIG. 7 depicts the file moved to the second folder;

FIG. 8 is a flow-chart of exemplary steps taken by a computer to convert a “copy” DnD operation into a “move” DnD operation;

FIG. 9 depicts an alternative embodiment in which DnD functionality is dependent on a direction that a source file icon approaches a target file icon;

FIG. 10 is a flow-chart of exemplary steps taken by a computer in accordance with the operation depicted in FIG. 9; and

FIG. 11 depicts an exemplary computer in which the present invention may be implemented.

### DETAILED DESCRIPTION OF THE PREFERRED EMBODIMENT

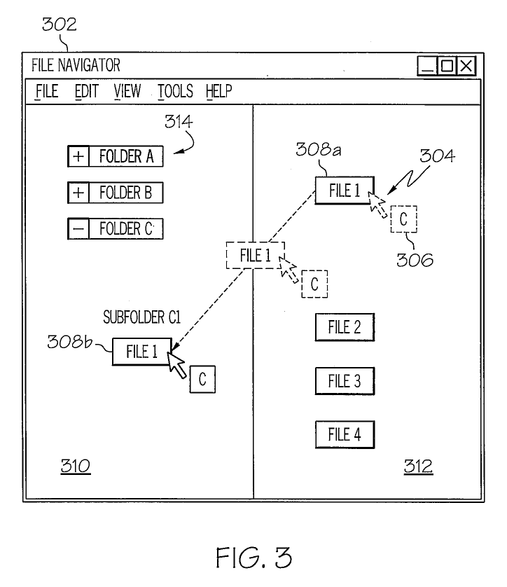

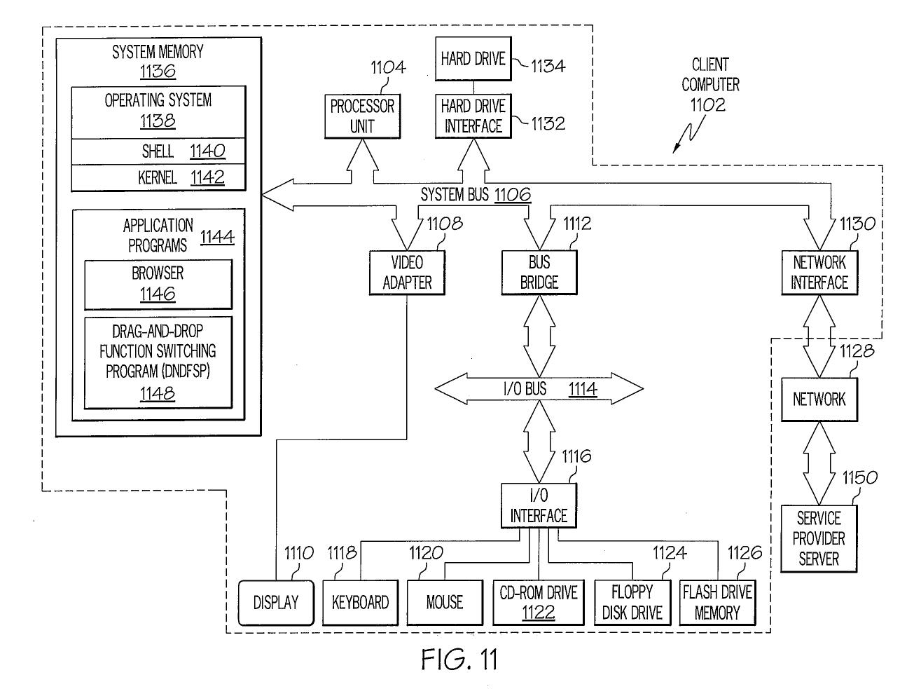

With reference now to FIG. 3, an exemplary “copy” Drag-and-Drop (DnD) operation is depicted using a cursor 304. As depicted, within a Graphical User Interface (GUI) 302 is a cursor 304, which is preferably mouse-controlled. Assume that the field 314 for “FOLDER A” in window 310 has previously been clicked, thus causing the file icons for Files 1-4 to appear in window 312. Through the use of the mouse (e.g., mouse 1120 shown below in FIG. 11), a user is able to click on a file icon, such as file icon 308a for File 1. By holding down a button (e.g., the left button) on the mouse, a copy (file icon 308b) of the original file icon 308a is created, dragged, and dropped into the area for SUBFOLDER C1 in window 310. This action results in an underlying file management operation, in which a copy of (or at least a pathway to) actual File 1 is created in SUBFOLDER C1. Note that this “copy” operation results in the original file icons for Files 1-4 remaining in window 312. Note also that, when in the “copy” DnD mode, the cursor 304 includes a function identifier box 306 that includes a “C” or other symbol to indicate that the “copy” DnD operation is in effect.

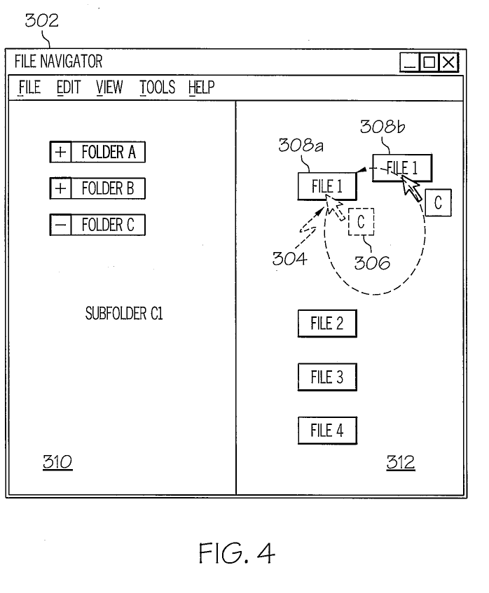

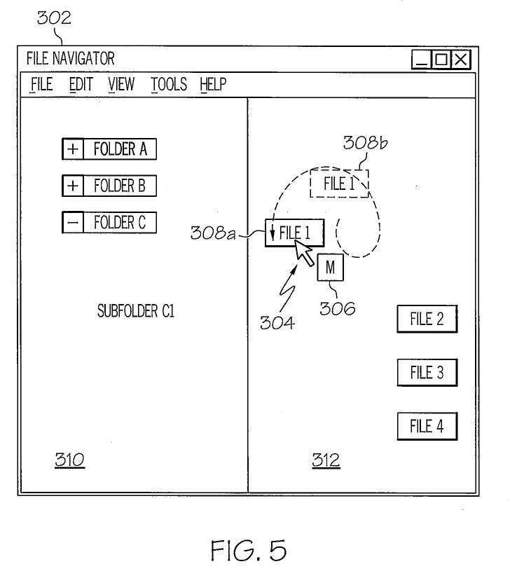

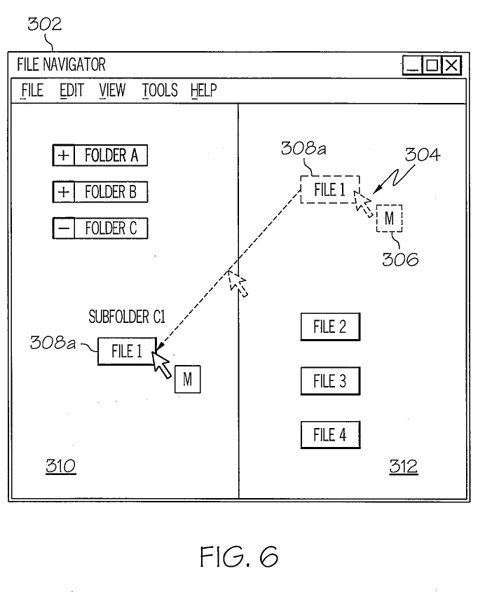

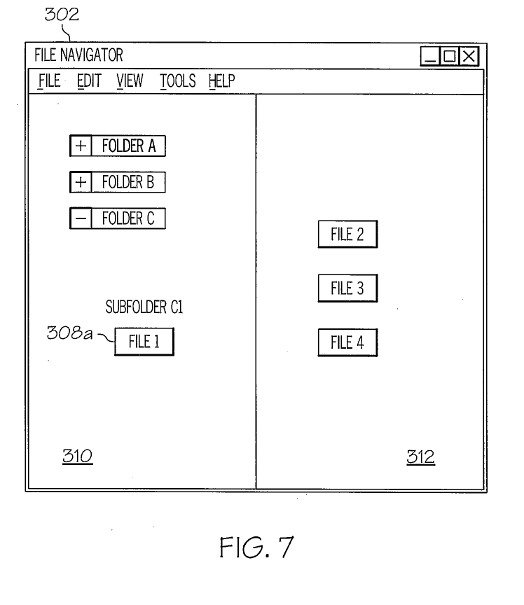

With reference to FIG. 4, a copy DnD operation has not occurred. Rather, the cursor 304 is being moved around, with the copy of the file icon 308b in tow, without the mouse button being released (to result in the completion of a “copy” DnD operation). As long at the cursor 304 (and/or the copy of the file icon 308b) does not move across the original real estate in which the original file icon 308a was initially located, the “copy” DnD functionality is still in effect. However, as soon as the cursor 304 (and/or the copy of the file icon 308b) traverses across the original location of the original file icon 308a, as shown in FIG. 5, the “copy” DnD operation automatically is converted into a “move” DnD operation. That is, as soon as the cursor 304 (and/or the copy of the file icon 308b) moves across the original file icon 308a, the copy file icon 308b disappears, as the cursor 304 “scoops up” the original file icon 308a. Note also that, by way of example, the content of function identifier box 306 switches from “C” (for “copy”) to “M” (for “move”). As shown in FIG. 6, the original file icon 308a is then moved in a DnD “move” operation manner to SUBFOLDER C1 in window 310. The final result is shown in FIG. 7, in which the file icons for the unmoved Files 2-4 remain in window 312, while the original file icon 308a for moved File 1 is now only in window 310.

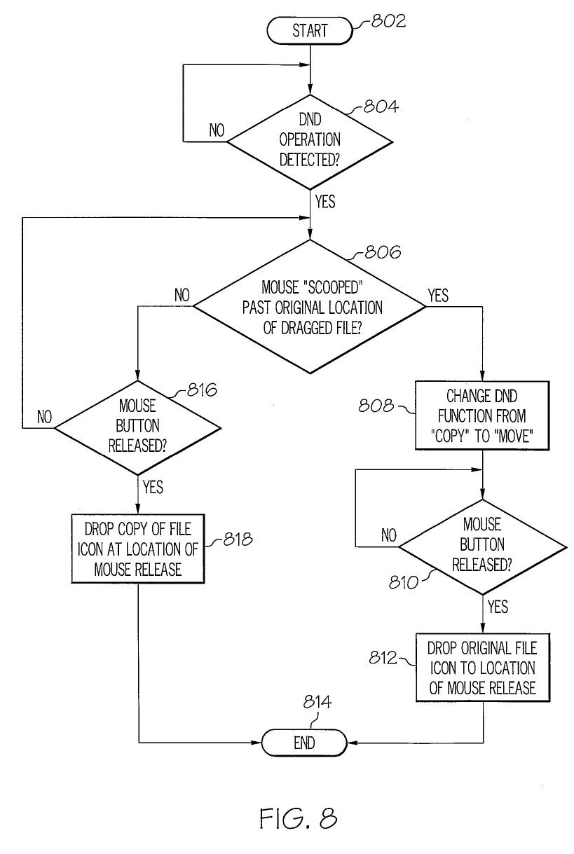

With reference now to FIG. 8, a flow-chart of exemplary steps taken by the present invention is presented. After initiator block 802, a Drop-and-Drag (DnD) operation may be detected (query block 804). This DnD operation is based on a cursor being placed over an original file icon in a GUI, a button (e.g., the left button) on a mouse being depressed (clicked) while the cursor is over the original file icon, and a copy of the file icon being created and moved away from the original file icon. If a DnD operation is detected, then cursor movement is monitored to detect if the cursor moves across the initial location of the original file icon (query block 806). If the cursor (and/or the copy of the original file icon) does in fact move across the original file icon, thus “scooping” the original file icon, then the DnD function is changed from a “copy” operation to a “move” operation (block 808). When the mouse button is released (query block 810), the original file icon is dropped wherever the cursor is located on the GUI at the time the mouse button is released (block 812), and the process ends (terminator block 814).

Returning now to query block 806, if the mouse button is released (query block 816) before the mouse scoops the original file icon (query block 806), then a copy of the file icon (generated by the DnD “copy” operation detected in query block 804) is dropped on the GUI wherever the cursor is located at the time the mouse button is released. The process thus ends at terminator block 814.

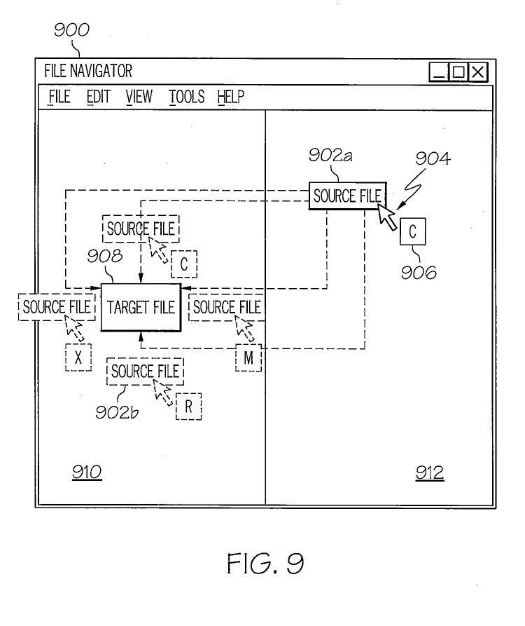

While the process described in the previous figures has been directed to a source file icon being an initiator of a change in a DnD operation, alternatively a target file icon, and in particular a direction from which the target file icon is approached, may alter a DnD operation. For example, consider the GUI 900 shown in FIG. 9. In window 912 is a source file icon 902a. Initially placed over source file icon 902a is a cursor 904, which has a function identifier box 906. Cursor 904 and function identifier box 906 have similar functionality as that described above for cursor 304 and function identifier box 306, in that they provide evidence in GUI 900 of which type of DnD operation is in effect. This DnD operation is initially a “copy” DnD operation, as suggested by the “C” in function identifier box 906. However, the DnD operation may change when the cursor 904 and a dragged copy 902b of the source file icon 902a approach a target file icon 908 in window 910. (Note that, in one embodiment, window 910 and window 912 may be a same window.)

As shown in FIG. 9, when the source file icon/cursor/function identifier box 902a/904/906 combination approach target file icon 908, the functionality of the DnD operation may remain the same, or it may change. For example, assume that the 902a/904/906 combination approaches the target file icon 908 from above. In that scenario, the functionality of the DnD operation may remain the same (“copy”). However, if the 902a/904/906 combination approaches the target file icon 908 from the right, then the DnD operation may change to a “move” DnD operation, as suggested by the “M” in the function identifier box 906. In this scenario, the original source file icon 902a will disappear when the dragged copy 902b is dropped on the target file icon 908. Similarly, the 902a/904/906 combination approaching the target file icon 908 from below may cause the “copy” DnD operation to change to a “replace” DnD operation, in which the file(s) associated with target file icon 908 are replaced by the file(s) associated with source file icon 902a. If the 902a/904/906 combination approaches the target file icon 908 from the left, then a pop-up or drop-down menu (not shown) will appear, allowing the user to choose any DnD operation listed in the menu. Note that the directions and DnD operations depicted are for exemplary purposes only, and are not to be construed as limiting which directional approach causes which particular DnD operation to come on line.

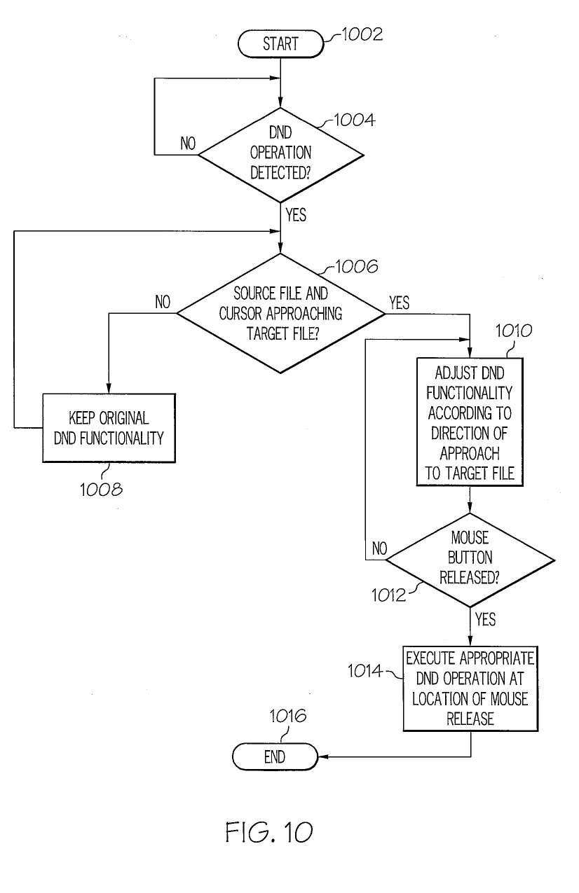

FIG. 10 is a flow-chart of exemplary steps shown in FIG. 9. After initiator block 1002, a query is made to determine if a DnD operation is occurring (query block 1004). This determination is made in a similar manner to that described above in block 804 of FIG. 8. As long as the file icon/cursor are not approaching a target file icon (query block 1006), then the DnD functionality remains the same (block 1008). However, if the file icon/cursor are approaching the target file icon (query block 1006), then the DnD functionality is adjusted according to the direction that the file icon/cursor are approaching the target file icon (block 1010). As soon as the mouse is released over the target file icon (query block 1012), then the appropriate DnD operation executes (block 1014) and the process ends (terminator block 1016).

With reference now to FIG. 11, there is depicted a block diagram of an exemplary client computer 1102, in which the present invention may be utilized. Client computer 1102 includes a processor unit 1104 that is coupled to a system bus 1106. A video adapter 1108, which drives/supports a display 1110, is also coupled to system bus 1106. System bus 1106 is coupled via a bus bridge 1112 to an Input/Output (I/O) bus 1114. An I/O interface 1116 is coupled to I/O bus 1114. I/O interface 1116 affords communication with various I/O devices, including a keyboard 1118, a mouse 1120, a Compact Disk-Read Only Memory (CD-ROM) drive 1122, a floppy disk drive 1124, and a flash drive memory 1126. The format of the ports connected to I/O interface 1116 may be any known to those skilled in the art of computer architecture, including but not limited to Universal Serial Bus (USB) ports.

Client computer 1102 is able to communicate with a service provider server 1150 via a network 1128 using a network interface 1130, which is coupled to system bus 1106. Network 1128 may be an external network such as the Internet, or an internal network such as an Ethernet or a Virtual Private Network (VPN).

A hard drive interface 1132 is also coupled to system bus 1106. Hard drive interface 1132 interfaces with a hard drive 1134. In a preferred embodiment, hard drive 1134 populates a system memory 1136, which is also coupled to system bus 1106. System memory is defined as a lowest level of volatile memory in client computer 1102. This volatile memory may include additional higher levels of volatile memory (not shown), including but not limited to cache memory, registers, and buffers. Data that populates system memory 1136 includes client computer 1102's operating system (OS) 1138 and application programs 1144.

OS 1138 includes a shell 1140, for providing transparent user access to resources such as application programs 1144. Generally, shell 1140 is a program that provides an interpreter and an interface between the user and the operating system. More specifically, shell 1140 executes commands that are entered into a command line user interface or from a file. Thus, shell 1140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 1142) for processing. Note that while shell 1140 is a text-based, line-oriented user interface, the present invention will equally well support other user interface modes, such as graphical, voice, gestural, etc.

As depicted, OS 1138 also includes kernel 1142, which includes lower levels of functionality for OS 1138, including providing essential services required by other parts of OS 1138 and application programs 1144, including memory management, process and task management, disk management, and mouse and keyboard management.

Application programs 1144 include a browser 1146. Browser 1146 includes program modules and instructions enabling a World Wide Web (WWW) client (i.e., client computer 1102) to send and receive network messages to the Internet using HyperText Transfer Protocol (HTTP) messaging, thus enabling communication with service provider server 1150.

Application programs 1144 in client computer 1102's system memory also include a Drag-and-Drop Function Switching Program (DnDFSP) 1148, which includes code for implementing the processes and Graphical User Interfaces (GUIs) described in FIGS. 3-10. Note that DnDFSP 1148 includes code for detecting mouse clicks, cursor positioning, and other program and GUI monitoring to determine when an initial “copy” DnD operation is occurring, and when the conversion to a “move” and/or other DnD operation occurs according to the process described above.

In one embodiment, client computer 1102 is able to download DnDFSP 1148 from service provider server 1150, preferably in an “on demand” basis.

Note that the hardware architecture for service provider server 1150 may be substantially similar to that shown for client computer 1102.

The hardware elements depicted in client computer 1102 are not intended to be exhaustive, but rather are representative to highlight essential components required by the present invention. For instance, client computer 1102 may include alternate memory storage devices such as magnetic cassettes, Digital Versatile Disks (DVDs), Bernoulli cartridges, and the like. These and other variations are intended to be within the spirit and scope of the present invention.

Note further that, in a preferred embodiment of the present invention, service provider server 1150 performs all of the functions associated with the present invention (including execution of DnDFSP 1148), thus freeing client computer 1102 from using its own resources.

It should be understood that at least some aspects of the present invention may alternatively be implemented in a computer-useable medium that contains a program product. Programs defining functions of the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

### Software Deployment

As described above, in one embodiment, the processes described by the present invention, including the functions of DnDFSP 1148, are performed by service provider server 1150. Alternatively, DnDFSP 1148 can be deployed as software from service provider server 1150 to client computer 1102. This deployment may be performed in an “on demand” basis manner, in which DnDFSP 1148 is only deployed when needed by client computer 1102. In another embodiment, process software for the method so described may be deployed to service provider server 1150 by another service provider server (not shown).

The present disclosure thus presents a method, system, and computer-readable medium for allowing a user to change a “copy” Drag-and-Drop (DnD) operation into a “move” DnD operation. In a preferred embodiment for converting a first type of Drag-and-Drop (DnD) operation into a second type of DnD operation, the computer-implementable method includes the steps of: detecting a first type of Drag-and-Drop (DnD) operation in which a cursor is dragging a copy of an original file icon across a Graphical User Interface (GUI); detecting the cursor dragging the copy of the original file icon across a location, on the GUI, at which the original file icon was positioned when the first type of DnD operation was initiated; and in response to detecting the cursor dragging the copy of the original file icon across the location at which the original file icon was initially positioned, converting the first type of DnD operation into a second type of DnD operation.

In another embodiment, an exemplary computer-implementable method for converting a first type of Drag-and-Drop (DnD) operation into a second type of DnD operation includes the steps of: detecting a first type of Drag-and-Drop (DnD) operation in which a cursor is dragging a copy of an original file icon across a Graphical User Interface (GUI); detecting the cursor and copy of the original file icon approaching a target file icon; and converting the first type of DnD operation into a second type of DnD operation according to a direction from which the cursor and copy of the original file icon approach the target file icon. If the first type of DnD operation is a copy DnD operation, the second type of DnD operation may also be a copy DnD operation that is implemented according to the cursor and copy of the original file icon approaching the target file icon from a first direction; or alternatively the second type of DnD operation may be a move DnD operation that is implemented according to the cursor and copy of the original file icon approaching the target file icon from a second direction; or alternatively the second type of DnD operation may be a replace DnD operation that is implemented according to the cursor and copy of the original file icon approaching the target file icon from a third direction; or alternatively the second DnD operation may be a DnD operation that is selected from an on-screen menu that is generated when the cursor and copy of the original file icon approach the target file icon from a fourth direction.

The method steps described above may be implemented in a computer system, and may further be executed by instructions that are stored in a computer readable medium.

In another embodiment, in which the method described herein is performed by software that is stored on a computer-readable medium, the computer-usable medium is a component of a remote server, and the computer executable instructions are deployable to a supervisory computer from the remote server. This deployment may be provided by a service provider to a customer on an on-demand basis.

While the present invention has been particularly shown and described with reference to a preferred embodiment, it will be understood by those skilled in the art that various changes in form and detail may be made therein without departing from the spirit and scope of the invention. Note that while “Copy” and “Move” are used to illustrate a preferred embodiment for dynamically converting a first type of DnD operation into a second type of DnD operation, any two types of DnD operations (e.g., scooping a widget or icon, deleting, etc.) may be converted using any method described herein. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

What is claimed is:

1. A computer-implementable method for converting a first type of Drag-and-Drop (DnD) operation into a second type of DnD operation, the computer-implementable method comprising:
detecting a first type of Drag-and-Drop (DnD) operation in which a cursor is dragging a copy of an original file icon across a Graphical User Interface (GUI);
detecting the cursor dragging the copy of the original file icon across a location, on the GUI, at which the original file icon was positioned when the first type of DnD operation was initiated; and
in response to detecting the cursor dragging the copy of the original file icon across the location at which the original file icon was initially positioned, converting the first type of DnD operation into a second type of DnD operation.

2. The computer-implementable method of claim 1, wherein the first type of DnD operation is a file copy operation, and wherein the second type of DnD operation is a file move operation.

3. A system comprising:
a processor;
a data bus coupled to the processor;
a memory coupled to the data bus; and
a computer-usable medium embodying computer program code, the computer program code comprising instructions executable by the processor and configured for preventing click fraud by performing the steps of:
detecting a first type of Drag-and-Drop (DnD) operation in which a cursor is dragging a copy of an original file icon across a Graphical User Interface (GUI);
detecting the cursor dragging the copy of the original file icon across a location, on the GUI, at which the original file icon was positioned when the first type of DnD operation was initiated; and
in response to detecting the cursor dragging the copy of the original file icon across the location at which the original file icon was initially positioned, converting the first type of DnD operation into a second type of DnD operation.

4. The system of claim 3, wherein the first type of DnD operation is a file copy operation, and wherein the second type of DnD operation is a file move operation.

5. A computer-readable medium encoded with a computer program, the computer program comprising computer executable instructions configured for:
detecting a first type of Drag-and-Drop (DnD) operation in which a cursor is dragging a copy of an original file icon across a Graphical User Interface (GUI);
detecting the cursor dragging the copy of the original file icon across a location, on the GUI, at which the original file icon was positioned when the first type of DnD operation was initiated; and
in response to detecting the cursor dragging the copy of the original file icon across the location at which the original file icon was initially positioned, converting the first type of DnD operation into a second type of DnD operation.

6. The computer-readable medium of claim 5, wherein the first type of DnD operation is a file copy operation, and wherein the second type of DnD operation is a file move operation.

7. The computer-readable medium of claim 5, wherein the computer-usable medium is a component of a remote server, and wherein the computer executable instructions are deployable to a supervisory computer from the remote server.

8. The computer-readable medium of claim 5, wherein the computer executable instructions are capable of being provided by a service provider to a customer on an on-demand basis.

9. A computer-implementable method for converting a first type of Drag-and-Drop (DnD) operation into a second type of DnD operation, the computer-implementable method comprising:
detecting a first type of Drag-and-Drop (DnD) operation in which a cursor is dragging a copy of an original file icon across a Graphical User Interface (GUI);
detecting the cursor and copy of the original file icon approaching a target file icon; and
converting the first type of DnD operation into a second type of DnD operation according to a direction from which the cursor and copy of the original file icon approach the target file icon.

10. The computer-implementable method of claim 9, wherein the first type of DnD operation is a copy DnD operation.

11. The computer-implementable method of claim 10, wherein the second type of DnD operation is a copy DnD operation that is implemented according to the cursor and copy of the original file icon approaching the target file icon from a first direction.

12. The computer-implementable method of claim 10, wherein the second type of DnD operation is a move DnD operation that is implemented according to the cursor and copy of the original file icon approaching the target file icon from a second direction.

13. The computer-implementable method of claim 10, wherein the second type of DnD operation is a replace DnD operation that is implemented according to the cursor and copy of the original file icon approaching the target file icon from a third direction.

14. The computer-implementable method of claim 10, wherein the second type of DnD operation is a DnD operation that is selected from an on-screen menu that is implemented according to the cursor and copy of the original file icon approaching the target file icon from a fourth direction.
